(19) United States
(12) Patent Application Publication
(10) Pub. No.: US 2006/0135218 A1
(43) Pub. Date: Jun. 22, 2006

(54) Method for indicating a battery charge level of a wireless headset

(76) Inventors: Jin Ho Son, Gwacheon-si (KR); Min Jung Kim, Seoul (KR); Chan Phil Yun, Gwacheon-si (KR)

Correspondence Address: MCKENNA LONG & ALDRIDGE LLP;Song K. Jung, 1900 K Street, N.W., Washington, DC, 20006, US

(21) Appl. No.: 11/290,471

(22) Filed: Dec. 1, 2005

(30) Foreign Application Priority Data
Dec. 2, 2004 (KR) 10-2004-0100598

(51) Int. Cl. H04B 1/38

(52) U.S. Cl. 455/573

(57) ABSTRACT

A battery charge remaining level indicating method of a wireless headset is disclosed. A remaining charge amount of a battery, disposed in a wireless headset and supplying power to the wireless headset, is transmitted to a mobile communication terminal connected to the wireless headset via short-range wireless communication, and indicated on a display. The battery charge remaining level is periodically discriminated by the wireless headset when the wireless headset and the mobile communication terminal are connected via short-range wireless communication. The discriminated information on the battery charge remaining level is transmitted to the mobile communication terminal. The mobile communication terminal discriminates the information on the battery charge remaining level transmitted by the wireless headset and indicates the battery charge remaining level on the display.

This application claims the benefit of Korean Patent Application No. 2004-0100598, filed on Dec. 2, 2004, which is hereby incorporated by reference for all purposes as if fully set forth herein.

### BACKGROUND OF THE INVENTION

1. Field of the Invention

The present invention relates to a battery charge remaining level indicating system and method of a wireless headset that is enabled to transmit and indicate on a mobile communication terminal, which is connected to the wireless headset via short-range wireless communication, a battery charge remaining level of a battery inherently associated with or disposed in the wireless headset.

2. Discussion of the Related Art

A wireless communication system is based on a cell, as a basic unit, formed by a base station. Mobile communication terminals are basically configured to receive communication services from a base station within a cell situated about its location.

Recently, various technologies have been proposed on a Wireless Personal Area Network (WPAN) for direct communication without recourse to a separate relay device such as a base station or the like.

Typically, the WPAN is a communication network using technology that permits communication within a very short range, such as ten meters, and comprises a relatively small number of mobile communication terminals or home appliances as composing elements. The widely known WPAN technologies include infrared communication, Bluetooth communication, WLAN, ZigBee communication and Ultra Wide Band (UWB) communication and the like.

The widely-used WLAN is intended to replace wired communication with wireless communication in a local area communication, and is anticipated to gain continued acceptance in consumer and commercial markets as an alternative to a wired LAN to its excellent interoperability. The Bluetooth technology is set forth in detail in Bluetooth Special Interest Group (SIG), Specification of the Bluetooth System, Version 1.0, July, 1999, as an official standard for Bluetooth by Bluetooth Special Interest Group (SIG) composed of an industry consortium including Ericsson, Nokia, IBM, Toshiba and Intel. IEEE 802.15 Working Group was set up as an official international standard group to closely cooperate with SIG for enactment of an international standard based on the Bluetooth standard.

The Bluetooth is a short-range wireless technology that uses the 2.4000˜2.4835 GHz within the Industrial, Scientific and Medical (ISM) band without a license and uses 79 hopping channels in 1 MHz bandwidth. Frequency Hopping Spread Spectrum techniques are employed by communicating Bluetooth devices that are enabled to change channels approximately 1,600 times per second for transmission of data. Maximum data transmission speed is 1 Mbps (Effective transmission speeds for two-way in consideration of the header of a packet are all 433.9 kbps, where one way is 723.2 kbps and the other way 57.6 kbps). It is set that the transmission distance is within approximately 10 km in case of 1 Mw of transmission power, and maximum transmission power is 100 Mw.

Having been designed to operate in a radio frequency environment that is laden with noises, Bluetooth enables stable data transmission and reception even at a noisy wireless frequency by using frequency hopping with the hopping rate of 1600 hops per second. Influences by multi-channel interference and narrow bandwidth impulse noise can be lessened by transmitting and receiving a predetermined packet and hopping in a new frequency. Consequently, Bluetooth communication hops faster than other systems operating in the same frequency band and can transmit data more stably by using a shorter packet.

Concomitant with the development of short-range wireless communication systems, consumers are provided with various convenient services. For example, a service is provided where a wireless headset and a mobile communication terminal are connected via short-range wireless communication. A link capable of transmitting voice signals is mutually formed such that a user can communicate via telephone without manipulating the mobile communication terminal. These prior arts are illustrated in FIGS. 1a and 1b.

FIG. 1a is a schematic representation of a mobile communication terminal being connected to a wireless headset for telephone communication according to the prior art.

As illustrated in FIG. 1a, a mobile communication terminal (100) functioning as a gateway is connected to a wireless headset (110) via short-range wireless communication if a call signal is received. The mobile communication terminal (100) transmits a ring signal to the wireless headset (110) to notify a user that a call signal has been received (S102).

Under this circumstance, if the user depresses a functional key disposed at the wireless headset (110) for telephone communication (S104), the wireless headset (110) creates a CKPD (Command of Keypad) message notifying that the functional key has been pressed and transmits it to the mobile communication terminal (100) (S106).

Successively, the mobile communication terminal (100) transmits a confirming message (OK) to the wireless headset (110) (S108). The mobile communication terminal (100) receives a call in response to the call signal, and forms a link capable of transmitting voice signals therebetween. For example, an SCO (Synchronous Connection Oriented) link is formed.

If the SCO link is formed, the mobile communication terminal (100) and the wireless headset (110) can transmit and receive voice signals via the SCO link, such that the user can tele-communicate with the call received by the mobile communication terminal (100).

FIG. 1b is a schematic representation of a wireless headset being connected to a mobile communication terminal for telephone communication according to the prior art.

In order for a user of the wireless headset (110) to tele-communicate via the mobile communication terminal (100), first of all, the user depresses a functional key equipped at the wireless headset (110) (S150). The wireless headset (110) is connected to the mobile communication terminal (100) via short-range wireless communication (S152).

If the wireless headset (110) and the mobile communication terminal (100) are connected, the wireless headset (110) transmits a CKPD message created by the depression of the functional key mounted on the wireless headset (110) to the mobile communication terminal (100) (S154). The mobile communication terminal (100) transmits a confirming message (OK) to the wireless headset (110) in response to the transmitted CKPD message (S156), whereby an SCO link is formed therebetween. (S158).

Furthermore, the mobile communication terminal (100) dials a predetermined telephone number in response to the CKPD message following the formation of the SCO link. For example, the mobile communication terminal (100) re-dials the last-dialed telephone number to call the other party.

If the other party answers the telephone in response to the re-dialing, the mobile communication terminal (100) and the wireless headset (110) transmit and receive voice signals via the formed SCO link such that the user can tele-communicate with the other party called by the mobile communication terminal (100) according to the depression of the functional key on the wireless headset (110).

Meanwhile, the wireless headset is inherently equipped with a battery for user mobility or hand-carrying Power charged in the battery enables the wireless headset to operate. It is therefore preferred that a battery charge remaining level be available to be checked at any time so that if the battery charge remaining level is low, the battery may be charged at once. However, the prior art thus described simply supports a user interface only, thereby lacking the ability to check the battery charge remaining level of the wireless headset via the mobile communication terminal.

The battery charge remaining level may be displayed by equipping the wireless headset with a battery charge remaining level detecting unit and an LCD or a Light Emitting Diode (LED). The wireless headset is worn on a head of a user. It is therefore cumbersome to display a battery charge remaining level on an LED or an LCD of a wireless headset as the user has to remove the wireless headset from the user's head every time the remaining level is to be checked. There is another disadvantage in that additional power is consumed by the headset as the remaining level on the LCD or LED is displayed.

### SUMMARY OF THE INVENTION

The object of the present invention is to provide a method and system of indicating a battery charge remaining level of a wireless headset by transmitting the battery charge remaining level to a mobile communication terminal and indicating it thereon.

In accordance with the object of the present invention, a battery charge level remaining level indicating method comprises: connecting a wireless headset to a mobile communication terminal via short-range wireless communication; the wireless headset periodically discriminating a battery charge remaining level of a built-in battery; transmitting to the mobile communication terminal information on the discriminated battery charge remaining level of the battery; and the mobile communication terminal indicating on a display window the battery charge remaining level of the battery based on the information on the transmitted battery charge remaining level.

The connection between the wireless headset and the mobile communication terminal is such that if a user manipulates a keypad of the mobile communication terminal to implement a wireless headset mode, the wireless headset mode is implemented to allow the mobile communication terminal to be connected to the wireless headset via short-range wireless communication.

The connection between the wireless headset and the mobile communication terminal is such that if a user depresses a functional key of the wireless headset, the wireless headset mode is implemented to allow the wireless headset to be connected to the mobile communication terminal via a short-range wireless communication.

The transmission of information on the battery charge remaining level includes transmission of a microphone volume gain control signal informing of a CKPD message and a battery charge remaining level, or transmission of a speaker volume gain control signal informing of a CKPD message and a battery charge remaining level.

The transmission of the microphone volume gain control signal or the speaker volume gain control signal is implemented within a predetermined time following the transmission of the CKPD message.

The battery charge remaining level indication is implemented by extracting a battery charge remaining level from the information on the battery charge remaining level transmitted by the wireless headset.

Information on the battery charge remaining level includes the microphone volume gain control signal or the speaker volume gain control signal received within the predetermined time following the receipt of the CKPD message, and a value of the microphone volume gain control signal or the speaker volume gain control signal includes the battery charge remaining level.

Information on the battery charge remaining level comprises a CKPD message. The CKPD message includes information informing of transmission of the battery charge remaining level, and the battery charge remaining level.

Indication of the battery charge remaining level is implemented by extracting information on the battery charge remaining level from the CKPD message, where the battery charge remaining level information comprises the CKPD message.

The transmission of information on the battery charge remaining level is implemented in such a fashion that the wireless headset establishes a serial port profile by which the battery charge remaining level is to be transmitted to the mobile communication terminal, and transmits the battery charge remaining level via the established serial port profile.

The serial port profile is any one of OBEX (Object Exchange), HSP (Head Set Profile), HFP (Hands Free Profile), LAP (LAN Access Profile) and DUN (Dial Up Networking Profile).

The present invention further comprises displaying on a display a battery charge remaining level discriminated by the wireless headset.

### BRIEF DESCRIPTION OF THE DRAWINGS

FIG. 1a is a schematic representation of a mobile communication terminal being connected to a wireless headset for telephone communication according to the prior art.

FIG. 1b is a schematic representation of a wireless headset being connected to a mobile communication terminal for telephone communication according to the prior art.

FIG. 2 is a block diagram illustrating a mobile communication terminal according to the present invention.

FIG. 3 is a block diagram illustrating a wireless headset according to the present invention.

FIG. 4 is a representation of operational aspects of a first embodiment of the present invention.

FIG. 5 is an exemplary representation of a status indicating a battery charge remaining level of a wireless headset on a mobile communication terminal according to the present invention.

FIG. 6 is a representation of a method according to a second embodiment of the present invention.

FIG. 7 is a representation of a method according to a third embodiment of the present invention.

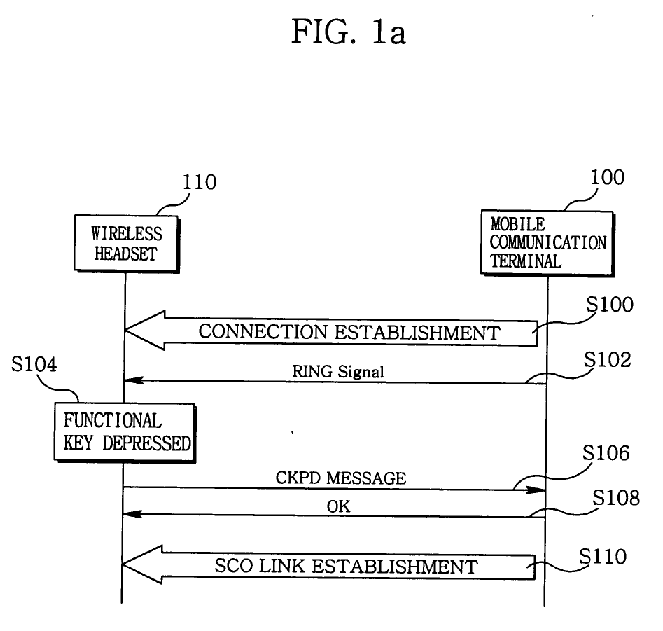

### DETAILED DESCRIPTION OF THE ILLUSTRATED EMBODIMENTS

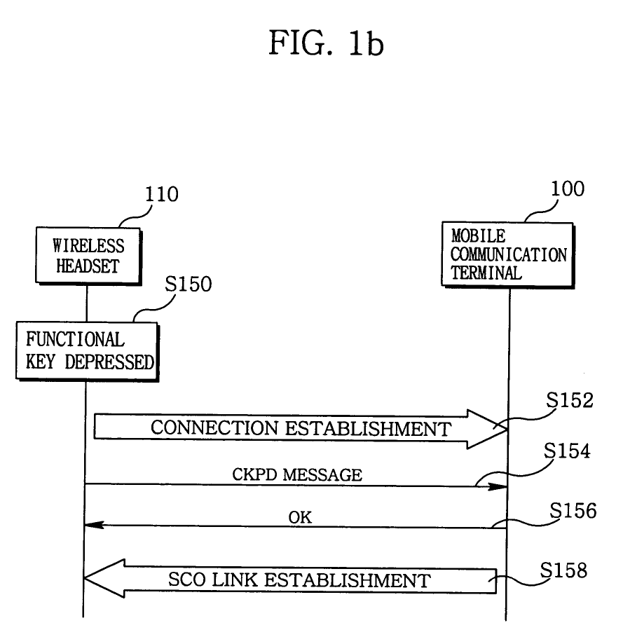

FIG. 2 is a block diagram illustrating a structure of a mobile communication terminal according to the present invention, where reference numeral 200 is a controller.

The controller (200) controls the entire operation of a mobile communication terminal. For example, the controller (200) implements a process and a control for voice telephone conversation and data communication, and supports tele-communication using a wireless headset. Furthermore, the controller (200) is generally a one chip microprocessor, and a mobile station modem chip manufactured by Qualcomm of USA may be used for the controller (200).

Reference numeral 202 denotes a radio frequency (RF) module, and 204 is a baseband processor. The RF module (202) receives an RF signal via an antenna and converts the received RF signal to a baseband signal and provides it to the baseband processor (204).

Furthermore, the RF module (202) converts the baseband signal inputted from the baseband processor (204) to RF signal and transmits it via the antenna. The baseband processor (204) is interposed between the RF mode (202) and the controller (200) to process the transmitted and received baseband signal. For example, the baseband processor (204) functions to channel-code and spread the transmission signal generated by the controller (200) if a predetermined signal is transmitted. Furthermore, if a predetermined signal is received, the processor (204) functions to despread and channel-decode the received signal.

Reference numeral (206) denotes a short-range communication module.

Reference numeral (216) denotes a keypad. The keypad (216) is disposed with number keys of 0-9, and a plurality of functional keys including menu, check, clear (CLR), END, *, # and the like. The keypad (216) creates a relevant key input data according to depression of a predetermined functional key by a user and inputs it to the controller (200).

Reference numeral (218) is a display. The display (218) indicates an operational state of the mobile communication terminal according to the control of the controller (200), and a battery charge remaining level of the wireless headset. The display (218) also indicates numerals, characters and symbols inputted by a user according to the control of the controller (200).

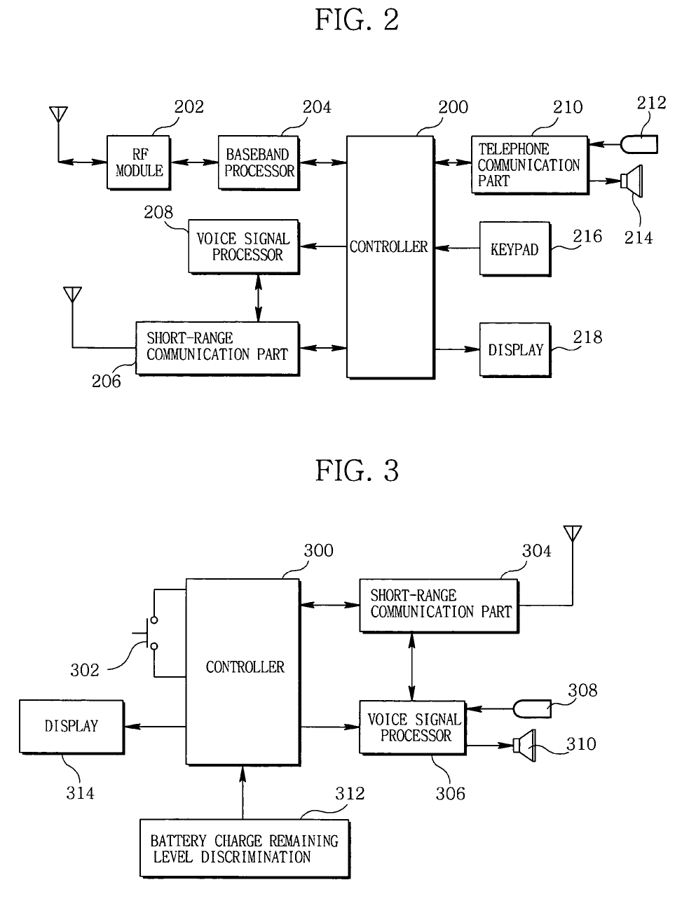

FIG. 3 is a block diagram illustrating a structure of a wireless headset according to the present invention, wherein reference numeral (300) is a controller and (302) is a functional key. The controller (300) controls the performances of the mobile communication terminal and the wireless headset. The controller (300) creates a CKPD message upon depression of the functional key by a user and controls the transmission of the created CKPD message to the mobile communication terminal via the short-range wireless communication. Furthermore, the controller (300) discriminates the battery charge remaining level and controls the transmission of the discriminated battery charge remaining level to the mobile communication terminal.

Reference numeral (304) denotes a short-range communication module. The short-range communication module (304) is connected to the wireless headset via the short-range wireless communication according to the control of the controller (300), and transmits battery charge remaining level information. Furthermore, the short-range communication module (304) forms a predetermined link, for example, an SCO link, with the mobile communication terminal and exchanges voice signals therebetween. The short-range communication module (304) uses, for example, Bluetooth, ZigBee, UWB or wireless LAN (WLAN).

Reference numeral (306) represents a voice signal processor. The voice signal processor (306) serves to encode the voice signal received via a microphone (308) and outputs it to the short-range communication module (304). The voice signal processor (306) decodes a voice signal received by short-range communication module (304) and outputs it to a speaker (310) to enable a user to tele-communicate.

Reference numeral (312) denotes a battery charge remaining level detector. The battery charge remaining level detector (312) detects a battery charge remaining level of the wireless headset, and transmits the detected level to the controller (300) and again sends it to the mobile communication terminal.

Reference numeral 314 denotes a battery charge remaining level display. The display (314) displays the battery charge remaining level detected by the battery charge remaining level detector (312) according to the control of the controller (300) and enables a user to check it.

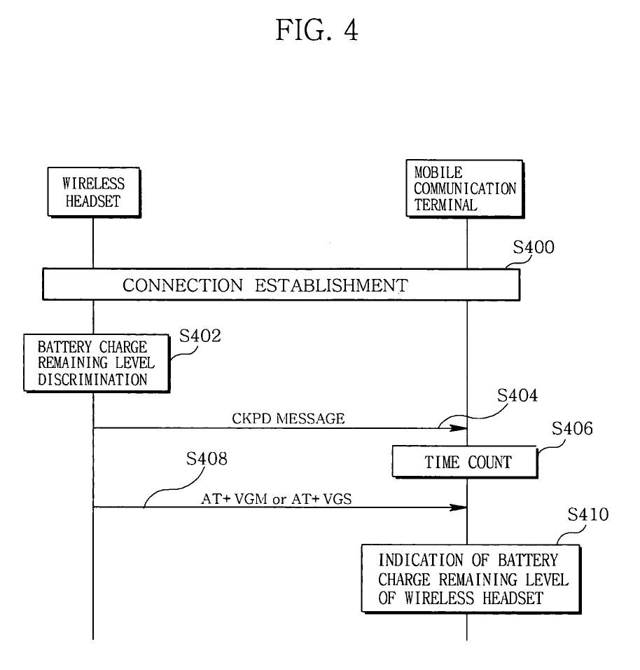

FIG. 4 is a representation of operation according to a first embodiment of the present invention.

First of all, the controller (200) of the mobile communication terminal and the controller (300) of the wireless headset are interconnected in order to implement short-range wireless communication via the short-range communication modules (206 and 304) based on a headset profile (S400). In other words, a user manipulates the keypad (216) of the mobile communication terminal to select a short-range wireless communication on an upper menu. Then, a wireless headset mode on a lower menu in the selected short-range wireless communication is executed to allow the mobile communication and the wireless headset to be connected via the short-range wireless communication. Or, if a user depresses the functional key of the wireless headset, the wireless headset mode is executed in response to the depression of the functional key to allow the mobile communication terminal and the wireless headset to be connected via short-range wireless communication.

For example, if the user depresses the functional key of the wireless headset, the wireless headset creates a CKPD message and transmits it to the mobile communication terminal. At this time, the CKPD message creates, for example, ‘CKPD=200’ required by Bluetooth communication and transmits it. The mobile communication terminal operates under a wireless headset mode in response to the transmitted CKPD message, creates a confirming message (OK), and transmits it to the wireless headset. Successively, the wireless headset mode is executed to allow the mobile communication terminal and the wireless headset to be connected via short-range wireless communication.

If the mobile communication terminal and the wireless headset are connected via short-range wireless communication, the battery charge remaining level detector of the wireless headset detects the battery charge remaining level, and the detected level is inputted into the controller (300) which in turn discriminates the remaining level (S402).

If the battery charge remaining level is discriminated, the controller (300) displays the battery charge remaining level on the display (314). Furthermore, the controller (300) creates the CKPD message and transmits the message to the mobile communication terminal (S404). For example, the controller (300) creates a string of ‘CKPD=200’ and transmits it to the mobile communication terminal.

The controller (200) of the mobile communication terminal counts or determines the amount of time (S406) that lapses if and when the CKPD message is received at S404.

Successively, the controller (300) of the wireless headset, using a microphone volume gain control signal (AT+VGM; Attention+Volume Gain Microphone) or a speaker volume gain control signal (AT+VGS; Attention+Volume Gain Speaker), transmits the battery charge remaining level information to the mobile communication terminal (S408).

For example, ‘AT+VGM=Battery charge remaining level information’ or ‘AT+VGS=Battery charge remaining level information’ is created for transmission to the mobile communication terminal. The battery charge remaining level information is configured to be divided, for example, into 15 levels, and if the remaining level is high, ‘15’ is transmitted, and if the level is low, a lower number is transmitted. If the remaining level calls for replenishment, the number of ‘1’ is transmitted.

The controller (200) of the mobile communication terminal discriminates a lapse time from receipt of the CKPD message (S404) to receipt of the microphone volume gain control signal or the speaker volume gain control signal if the microphone volume gain control signal or the speaker volume gain control signal is received at S408. As a result of the discrimination, if the time lapse is within a pre-set time period, for example, 0.7 ms, the controller (200) discriminates that the microphone volume gain control signal or the speaker volume gain control signal is the battery charge remaining level information of the wireless headset, and the battery charge remaining level is indicated by way of a value of the microphone volume gain control signal or the speaker volume gain control signal (S410).

Furthermore, as a result of the discrimination, if the microphone volume gain control signal or the speaker volume gain control signal is received, and if a pre-set time period has lapsed following receipt of the CKPD message, the controller (200) of the mobile communication terminal discriminates the microphone volume gain control signal or the speaker volume gain control signal as a signal for controlling the microphone volume gain or the speaker volume gain, and adjusts the microphone volume gain or the speaker volume gain in the same manner, as discussed.

In the first embodiment of the present invention, the CKPD message, the microphone volume gain control signal or the speaker volume gain control signal is used for the battery charge remaining level of the wireless headset to be transmitted to the mobile communication terminal. In other words, the present invention is such that, if the controller (300) of the wireless headset transmits the battery charge remaining level to the mobile communication terminal, the CKPD message is first transmitted, and successively, the battery charge remaining level is transmitted using the microphone volume gain control signal or the speaker volume gain control signal before the pre-set time period lapses. The controller (200) of the mobile communication terminal counts or determines the amount of time spent for receipt of the microphone volume gain control signal or the speaker volume gain control signal, following the receipt of the CKPD message. Furthermore, if the microphone volume gain control signal or the speaker volume gain control signal is received within the pre-set time period, the value of the microphone volume gain control signal or the speaker volume gain control signal is discriminated to be the battery charge remaining level information and is indicated on the display.

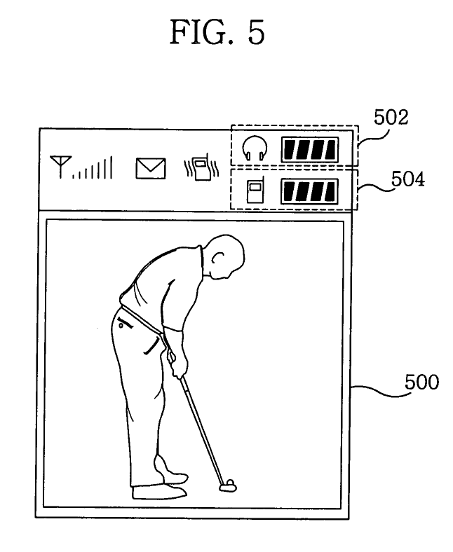

FIG. 5 is an exemplary representation of a status indicating a battery charge remaining level of a wireless headset on a mobile communication terminal according to the present invention. In the present invention, a display window (500) of the display (218) is divided into two sections: one section is a region (502) indicating the battery charge remaining level of the wireless headset; and the other section is a region (504) indicating the battery charge remaining level of the mobile communication terminal. The region (502) indicating the battery charge remaining level of the wireless headset is displayed with the battery charge remaining level received from the wireless headset as mentioned earlier. The region (504) indicating the battery charge remaining level of the mobile communication terminal is displayed with the battery charge level remaining in a battery of the mobile communication terminal.

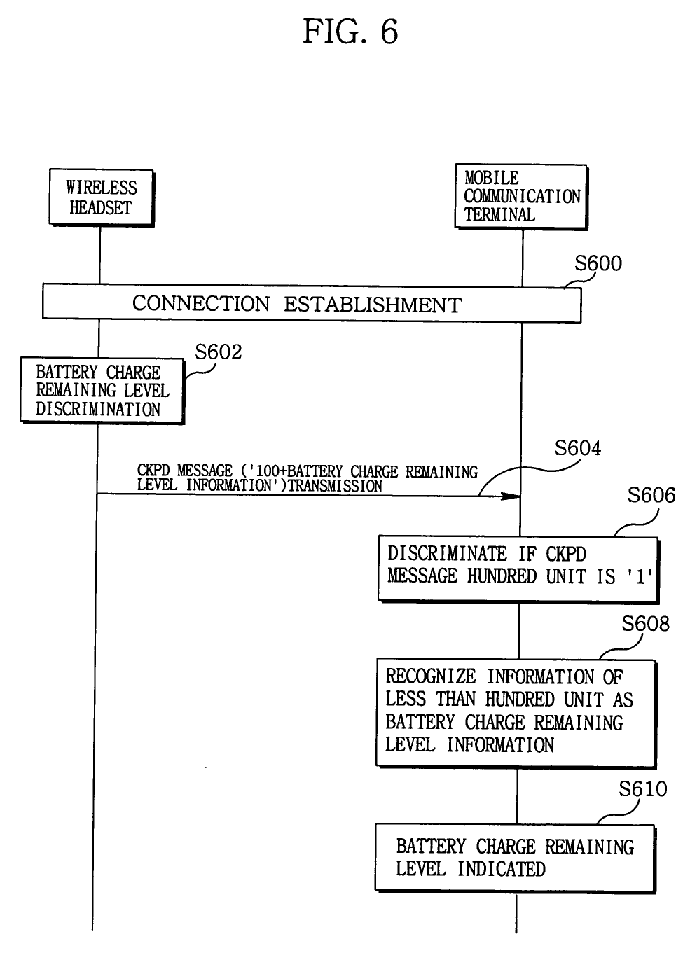

FIG. 6 is a representation of a method according to a second embodiment of the present invention, wherein steps S600 and S602 are the same as those of S400 and S402, such that detailed explanation thereto is omitted.

The controller (300) of the wireless headset controls the display (314) to display the battery charge remaining level (S610). Furthermore, the controller (300) creates CKPD message informing of the battery charge remaining level and transmits it to the mobile communication terminal (S604). The CKPD message of S604 includes ‘CKPD’ informing of the CKPD message, information ‘100’ informing the transmission of the battery charge remaining level information, and ‘the battery charge remaining level information’. For example, if it is assumed that the battery charge remaining level information is ‘15’, the CKPD message is transmitted as a string of ‘CKPD=115’.

If the CKPD message is received, the controller (200) of the mobile communication terminal discriminates whether a hundred unit digit of the CKPD message is ‘1’ (S606). As a result of the discrimination, if the hundred unit digit of the CKPD message is ‘1’, the controller (200) discriminates information of less than a hundred unit as the battery charge remaining level information (S608), and indicates the battery charge remaining level on the display (218) (S610).

In other words, in the second embodiment of the present invention, the controller (300) of the wireless headset creates information advising of transmission of the battery charge remaining level information and a CKPD message as the battery charge remaining level information and transmits the same to the mobile communication terminal. The controller (200) of the mobile communication terminal, if the CKPD message is received, discriminates whether the hundred unit digit is ‘1’ informing of the transmission of the battery charge remaining level, and if the ‘1’ is the information advising of the transmission of the battery charge remaining level as a result of the discrimination, the controller (200) recognizes that the information of less than a hundred unit is the battery charge remaining level information, and indicates the battery charge remaining level on the display (218) (S610).

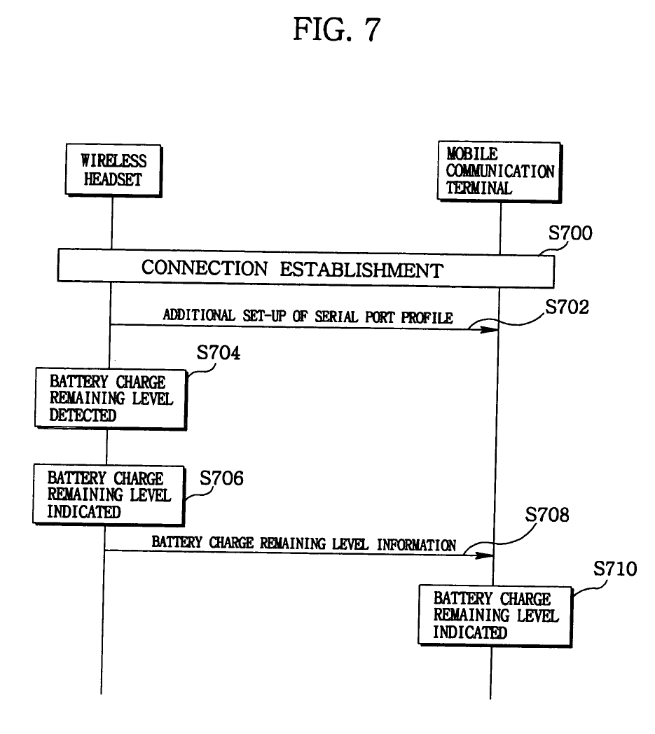

FIG. 7 is a representation of a method according to a third embodiment of the present invention, where step of S700 is the same as that of S400 in the first embodiment of the present invention such that explanation of detailed operation thereto will be omitted.

At S700, under a state where the wireless headset and the mobile communication terminal are connected via a short-range communication, the controller (300) of the wireless headset further establishes a serial port profile to be used for transmission of the battery charge remaining level information (S702). The serial port profile thus added is a profile capable of implementing a function of replacing or emulating the existing wired RS-232 cable. For example, a basic route in which profiles such as OBEX(Object Exchange), HSP (Head Set Profile), HFP (Hands Free Profile), LAP (LAN Access Profile), DUN (Dial Up Networking Profile) operate is established, or a user uses a serial port profile to implement a predetermined function.

If the serial port profile is established, the controller (300) of the wireless headset discriminates the battery charge remaining level by way of the detected signal of the battery charge remaining level detector (312) (S704). If the battery charge remaining level is discriminated, the controller (300) controls the display (314) and displays the battery charge remaining level (S706). Furthermore, the controller (300) transmits the battery charge remaining level information to the mobile communication terminal by a string using the established serial port profile (S708). For example, if it is assumed that the additionally established profile is OBEX, a string containing the battery charge remaining level information as ‘OBEX_BATTERY-XX’ is transmitted to the mobile communication terminal. The XX is a value advising of the battery charge remaining level information.

If the string containing the battery charge remaining level information is received from the wireless headset, the controller (200) of the mobile communication terminal extracts the battery charge remaining level information from the string to discriminate the battery charge remaining level of the wireless headset, and displays the discriminated level on the display (218) (S710).

In other words, in transmitting and indicating the battery charge remaining level information of the wireless headset to the mobile communication terminal in the third embodiment of the present invention, first of all, the wireless headset establishes a serial port profile for transmitting the battery charge remaining level information to the mobile communication terminal. The wireless headset uses the established profile to transmit the battery charge remaining level information to the mobile communication terminal, where the mobile communication terminal extracts the battery charge remaining level information from the profile received from the wireless headset and indicates the information on the display (218).

According to the first, second and third embodiments of the present invention, the battery charge remaining level information is transmitted from the wireless headset to the mobile communication terminal. The mobile communication terminal extracts the battery charge remaining level information transmitted from the wireless headset and indicates the extracted battery charge remaining level information on the display.

Therefore, there is an advantage in the battery charge remaining level indicating method of a wireless headset according to the present invention thus described in that a user can easily check the battery charge remaining level information of the wireless headset using a display window of the mobile communication terminal, and if there is a lack of battery remaining power, the battery can be readily recharged, whereby, missing of important telephone communication can be prevented in advance.

While various embodiments of the present invention have been described, it will be apparent to those of ordinary skill in the art that many more embodiments and implementations are possible within the scope of the invention. Accordingly, the invention is not to be restricted except in accordance with the attached claims and their equivalents.

What is claimed is:

1. A method for indicating a battery charge level said method comprising:
connecting a wireless headset to a mobile communication terminal via short-range wireless communication;
periodically discriminating, via the wireless headset, a battery charge level of a built-in battery of the wireless headset;
transmitting to the mobile communication terminal, information on the discriminated battery charge level; and
indicating, via the mobile communication terminal, on a display window the discriminated battery charge level of the battery based on the transmitted information.

2. The method as defined in claim 1, wherein the connection between the wireless headset and the mobile communication terminal is such that if a keypad of the mobile communication terminal is manipulated to implement a wireless headset mode, the wireless headset mode is configured to connect the mobile communication terminal to the wireless headset via short-range wireless communication.

3. The method as defined in claim 1, wherein the connection between the wireless headset and the mobile communication terminal is such that if a functional key of the wireless headset is activated, the wireless headset mode is configured to connect the wireless headset to the mobile communication terminal via short-range wireless communication.

4. The method as defined in claim 1, wherein the transmission of information on the battery charge level includes transmission of a microphone volume gain control signal informing of a CKPD message and a battery charge level, or a transmission of a speaker volume gain control signal informing of a CKPD message and a battery charge level.

5. The method as defined in claim 4, wherein the transmission of the microphone volume gain control signal or the speaker volume gain control signal is implemented within a predetermined time period following the transmission of the CKPD message.

6. The method as defined in claim 1, wherein said indicating of the battery charge level includes extracting a battery charge level from the information on the battery charge level transmitted by the wireless headset.

7. The method as defined in claim 6, wherein the information on the battery charge level includes the microphone volume gain control signal or the speaker volume gain control signal received within a predetermined time period following receipt of a CKPD message; wherein a value of the microphone volume gain control signal or the speaker volume gain control signal includes the battery charge level.

8. The method as defined in claim 1, wherein the information on the battery charge level is included in a CKPD message.

9. The method as defined in claim 8, wherein the CKPD message comprises:
transmission information of the battery charge level; and
the battery charge level.

10. The method as defined in claim 1, wherein said indicating of the battery charge level includes extracting the information on the battery charge level from a CKPD message; wherein the information on the battery charge level is included in the CKPD message.

11. The method as defined in claim 1, wherein the transmission of the information on the battery charge level is implemented such that the wireless headset establishes a serial port profile by which the battery charge level is to be transmitted to the mobile communication terminal, and transmits the battery charge level via the established serial port profile.

12. The method as defined in claim 11, wherein the serial port profile includes any one of OBEX (Object Exchange), HSP (Head Set Profile), HFP (Hands Free Profile), LAP (LAN Access Profile) and DUN (Dial Up Networking Profile).

13. The method as defined in claim 1, further comprising displaying on a display of the mobile communication terminal, the battery charge level discriminated by the wireless headset.

14. A method for indicating a battery charge level of a headset, said method comprising:
receiving, via short-range wireless communication, a battery charge level of a headset, wherein the battery charge level is discriminated by the headset; and
displaying the battery charge level on a display screen.

15. The method according to claim 14, wherein the battery charge level is included in a CKPD message.

16. The method according to claim 14, further comprising receiving a CKPD message from the headset for a predetermined time period prior to said receiving of the battery charge level.

17. The method according to claim 14, wherein the battery charge level is included with a microphone volume gain control signal or a speaker volume gain control signal.

18. A method for indicating a battery charge level of a headset, said method comprising:
connecting to a mobile communication terminal that is configured for at least voice communication, via short range wireless communication;
discriminating a battery charge level of a headset;
transmitting the discriminated battery charge level of the headset such that the discriminated battery charge level is configured to be displayed on a display screen of the mobile communication terminal.

19. The method according to claim 18, wherein the battery charge level is included in a CKPD message.

20. The method according to claim 18, wherein the battery charge level is included with a microphone volume gain control signal or a speaker volume gain control signal.
